(19) United States
(12) Patent Application Publication
(10) Pub. No.: US 2009/0092840 A1
(43) Pub. Date: Apr. 9, 2009

(54) Catalysis System

(75) Inventors: Michael Schlumpf, Stallikon (CH); Martin Konstanzer, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/224,991

(22) PCT Filed: May 24, 2007
(86) PCT No.: PCT/EP2007/055051

§ 371 Date: Sep. 23, 2008

(30) Foreign Application Priority Data
May 24, 2006 (EP) 06114497.8

(51) Int. Cl. B32B 27/40; C08G 18/22; C08G 18/26; B60J 1/00; C08L 75/04; B32B 37/12

(52) U.S. Cl. 428/423.1; 528/56; 528/55; 524/871; 525/453; 156/331.4; 296/146.1

(57) ABSTRACT

A two-component adhesive or sealant composition consists of a first component (K1) comprising a prepolymer P, which displays an isocyanate group, and an acceleration component (K2). The said acceleration component (K2) displays a catalyst, which catalyzes the reaction of isocyanate groups and which is a lead, zinc, or iron (III) complex, as well as compounds displayed on isocyanate-reactive groups that are at most 1% by weight. In particular, adhesives with a high cure velocity and good adhesion can be obtained and adapted very easily to ambient conditions.

### FIELD OF THE INVENTION

The field of the present invention relates to the field of polyurethane adhesives and sealants.

### DESCRIPTION OF THE PRIOR ART

Polyurethane sealants and adhesives are well established and in widespread use. Conventionally a distinction is made in the art between one-component and two-component polyurethane adhesives. One-component polyurethane adhesives react fully under the influence of atmospheric moisture. Known two-component polyurethane adhesives include as second components a curative component, comprising essentially polyamines and/or polyols. In both cases, compounds containing isocyanate groups or prepolymers are used. To accelerate the crosslinking, catalysts are added to the compounds containing isocyanate groups, or prepolymers, in both types. For example, EP-B-0 737 699 discloses amine, tin or mercury catalysts for accelerating moisture-crosslinking polyurethane adhesives and sealants.

Conventional catalysts for one-component polyurethane adhesives are considered more particularly to include amine catalysts and organotin catalysts, more particularly dibutyltin dilaurate.

For the abovementioned two-component systems, other metal catalysts are known besides the amine and organotin catalysts mentioned.

A disadvantage of the one-component polyurethane adhesives is that they cure very slowly, typically over days. Rapid curing, however, is a major requirement in the adhesives industry, more particularly in the automobile industry. In order to obtain a rapid reaction, therefore, conventional two-component polyurethane adhesives are often used, with an isocyanate component and a curative component. The major drawback of the two-component polyurethane adhesives, however, is that exacting requirements must be imposed on the quality of mixing, since even small mixing errors can lead to a sharp drop in mechanical values.

Both one-component and two-component polyurethane adhesives often have problems in attaching to coating-material substrates, more particularly to automobile topcoats.

### SUMMARY OF THE INVENTION

It is an object of the present invention, therefore, to provide a polyurethane composition which cures rapidly, is insensitive to mixing errors, and exhibits good adhesion to painted substrates, especially to automobile topcoats.

Surprisingly it has been found that a two-component adhesive or sealant composition as claimed in claim 1 solves this problem. A great advantage of such a composition is that the accelerator component can be added to any desired one-component polyurethane adhesive as a first component, and that the curing thereof is accelerated strongly without the problem of mixing accuracy that is typical of two-component adhesives. It has emerged, furthermore, that these two-component polyurethane compositions possess very good adhesion behavior to painted substrates, especially to automobile topcoats. Finally, the present invention makes it possible in a simple way to adjust the curing for winter and summer climatic conditions, with the aim of combining good curing and adhesion.

### DESCRIPTION OF THE PREFERRED EMBODIMENTS

The present invention relates first to a two-component adhesive or sealant composition which is composed of a first component K1 and an accelerator component K2.

The first component K1 comprises at least one prepolymer P which contains isocyanate groups and is prepared from at least one polyisocyanate and at least one polyol.

The accelerator component K2 contains not more than 1% by weight, more particularly not more than 0.1% by weight, based on the weight of the accelerator component K2, of compounds containing isocyanate-reactive groups. There are therefore only traces of these compounds in the composition. If the amount is larger, either the requirements concerning the quality of mixing go up, or the accelerator component K2 is not stable on storage for prolonged periods.

“Compounds containing isocyanate-reactive groups” are considered compounds which react with isocyanate groups at room temperature, more particularly compounds which contain free primary or secondary amino groups, mercapto groups or hydroxyl groups, or else water.

The accelerator component K2 preferably contains no compounds with isocyanate-reactive groups, and in particular is free from water, free from polyamines, free from polymercaptans, and free from polyols.

The prefix “poly” in substance names, such as “polyol”, “polyamine”, “polymercaptan” or “polyisocyanate”, in the present document indicates that the substance in question contains, formally, more than one per molecule of the functional group that occurs in its name.

The first component K1 comprises at least one prepolymer P which contains isocyanate groups and which is prepared from at least one polyisocyanate and at least one polyol. A preparation of this kind may be accomplished by the polyol and the polyisocyanate being reacted by customary processes, at temperatures of 50° C. to 100° C., for example, where appropriate with accompanying use of suitable catalysts, the polyisocyanate being metered such that its isocyanate groups are in stoichiometric excess in relation to the hydroxyl groups of the polyol.

More particularly the excess of polyisocyanate is chosen such that the free isocyanate group content of the resulting polyurethane prepolymer, after all of the polyol hydroxyl groups have reacted, is 0.1%-5% by weight, preferably 0.25%-2.5% by weight, more preferably 0.3%-1% by weight, based on the polymer as a whole.

Where appropriate the polyurethane polymer P can be prepared using plasticizers, in which case the plasticizers used contain no isocyanate-reactive groups.

Preference is given to polyurethane prepolymers having the stated free isocyanate group content which are obtained from the reaction of diisocyanates with high molecular mass diols in an NCO/OH ratio of 1.5/1 to 2/1.

Polyols which can be used for preparing a prepolymer P containing isocyanate groups include, for example, the following commercially commonplace polyols, or any desired mixtures of them:
polyoxyalkylene polyols, also called polyether polyols or oligoetherols, which are polymerization products of ethylene oxide, 1,2-propylene oxide, 1,2- or 2,3-butylene oxide, tetrahydrofuran or mixtures of them, optionally polymerized by means of a starter molecule having two or more active hydrogen atoms, such as, for example, water, ammonia or compounds having two or more OH or NH groups, such as, for example, 1,2-ethanediol, 1,2- and 1,3-propanediol, neopentyl glycol, diethylene glycol, triethylene glycol and polyethylene glycols, the isomeric dipropylene glycols, tripropylene glycols, and polypropylene glycols, the isomeric butanediols, pentanediols, hexanediols, heptanediols, octanediols, nonane-diols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and also mixtures of the aforementioned compounds. Use may be made not only of polyoxyalkylene polyols which have a low degree of unsaturation (measured to ASTM D-2849-69 and reported in milliequivalents of unsaturation per gram of polyol (meq/g)), prepared, for example, with the aid of what are called double metal cyanide complex catalysts (DMC catalysts), but also of polyoxyalkylene polyols having a higher degree of unsaturation, prepared, for example, with the aid of anionic catalysts such as NaOH, KOH, CsOH or alkali metal alkoxides.

Particular suitability is possessed by polyoxyalkylene diols or polyoxyalkylene triols, more particularly polyoxypropylene diols or polyoxypropylene triols.

Especially suitable are polyoxyalkylene diols or polyoxyalkylene triols having a degree of unsaturation of less than 0.02 meq/g and having a molecular weight in the range of 1000-30 000 g/mol, and also polyoxypropylene diols and triols having a molecular weight of 400-8000 g/mol. The term “molecular weight” in the present document refers to the molecular weight average Mₙ.

Likewise particularly suitable are what are called ethylene oxide-terminated (“EO-endcapped”, ethylene oxide-endcapped) polyoxypropylene polyols. The latter are special polyoxypropylene-polyoxyethylene polyols which are obtained, for example, by subjecting pure polyoxypropylene polyols, more particularly polyoxypropylene diols and triols, after the end of the polypropoxylation reaction, to continued alkoxylation with ethylene oxide, and which as a result contain primary hydroxyl groups.

Styrene-acrylonitrile- or acrylonitrile-methyl methacrylate-grafted polyether polyols.

Polyester polyols, also called oligoesterols, prepared, for example, from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters, such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid, or mixtures of the aforementioned acids, and also polyester polyols formed from lactones such as ε-caprolactone, for example.

Polycarbonate polyols, of the kind obtainable by reaction, for example, of the abovementioned alcohols—those used to synthesize the polyester polyols—with dialkyl carbonates, diaryl carbonates or phosgene.

Polyacrylate and polymethacrylate polyols.

Polyhydrocarbon polyols, also called oligohydro-carbonols, such as, for example, polyhydroxy-functional ethylene-propylene, ethylene-butylene or ethylene-propylene-diene copolymers, of the kind manufactured, for example, by the company Kraton Polymers, or polyhydroxy-functional copolymers of dienes such as 1,3-butanediene or diene mixtures and vinyl monomers such as styrene, acrylonitrile or isobutylene, or polyhydroxy-functional polybutadiene polyols, of the kind, for example, prepared by copolymerizing 1,3-butadiene and allyl alcohol.

Polyhydroxy-functional acrylonitrile/polybutadiene copolymers, of the kind, for example, preparable from epoxides or amino alcohols and carboxyl-terminated acrylonitrile/polybutadiene copolymers (available commercially under the name Hycar® CTBN from Noveon).

These stated polyols have an average molecular weight of 250-30 000 g/mol, more particularly of 1000-30 000 g/mol, and an average OH functionality in the range from 1.6 to 3.

Preferred polyols are polyoxyalkylene polyols. Additionally preferred as polyols are diols. Particular preference is given to polyoxyalkylene diols, more particularly those having a degree of unsaturation of less than 0.02 meq/g and a molecular weight in the range of 4000-30 000 g/mol, more particularly 8000-30 000 g/mol.

In addition to these stated polyols it is possible alongside them to use small amounts of low molecular weight dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other polyfunctional alcohols, low molecular weight alkoxylation products of the aforementioned dihydric and polyhydric alcohols, and also mixtures of the aforementioned alcohols, when preparing the polyurethane polymer containing terminal isocyanate groups.

As polyisocyanates for preparing a prepolymer p containing isocyanate groups it is possible for example to use the following commercially commonplace polyisocyanates:

1,6-hexamethylene diisocyanate (HDI), 2-methylpenta-methylene 1,5-diisocyanate, 2,2,4- and 2,4,4-trimethyl-1,6-hexamethylene diisocyanate (TMDI), 1,12-dodeca-methylene diisocyanate, lysine diisocyanate and lysine ester diisocyanate, cyclohexane 1,3- and 1,4-diisocyanate and any desired mixtures of these isomers, 1-isocyanato-3,3,5-trimethyl-5-isocyanatomethylcyclo-hexane (i.e., isophorone diisocyanate or IPDI), perhydro-2,4′- and -4,4′-diphenylmethane diisocyanate (HMDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3- and -1,4-xylylene diisocyanate (m- and p-TMXDI), bis(1-isocyanato-1-methylethyl(naphthalene), 2,4- and 2,6-tolylene diisocyanate and any desired mixtures of these isomers (TDI), 4,4′-, 2,4′-, and 2,2′-diphenylmethane diisocyanate and any desired mixtures of these isomers (MDI), 1,3-, and 1,4-phenylene diisocyanate, 2,3,5,6-tetramethyl-1,4-diisocyanato-benzene, naphthalene 1,5-diisocyanate (NDI), 3,3′-dimethyl-4,4′-diisocyanatobiphenyl (TODI), oligomers and polymers of the aforementioned isocyanates, and also any desired mixtures of the aforementioned isocyanates. Preference is given to MDI, TDI, HDI, and IPDI.

In the course of the preparation and storage of the prepolymer P containing isocyanate groups, care should be taken to ensure that any contact with water or moisture, as far as possible, is ruled out. Consequently the preparation and storage take place under nitrogen and in impervious apparatus and containers.

The accelerator component K2 comprises at least one catalyst C which catalyzes the reaction of isocyanate groups. This catalyst C is a lead complex or a zinc complex or an iron(III) complex.

By “lead complex” or “zinc complex” or “iron(III) complex” are meant coordination compounds comprising lead or zinc or iron(III) as the central atom and comprising ligands which are attached coordinately to lead or zinc or iron(III). The ligands may be organic or inorganic in nature. Depending on the type and charge of the respective ligands, the complex is a neutral complex or a complex anion or complex cation. Complexes which have proved particularly suitable are lead and zinc and iron(III) complexes which contain organic ligands attached via oxygen atoms to the lead, zinc or iron(III). With particular preference the organic ligands contain at least 2 oxygen atoms. Organic carboxylates have proven to be particularly suitable such ligands.

Particular suitability has been shown by tetravalent zinc or lead complexes or hexavalent iron(III) complexes. The most preferred zinc and lead complexes are those known as metal soaps of zinc or lead, representing zinc complexes or lead complexes of fatty acid carboxylates or naphthenates. In the case of iron(III), the most preferred complexes besides the metal soaps are the acetylacetonato-iron(III) complexes.

Examples of particularly suitable zinc complexes are zinc octoate, zinc neodecanoate, zinc 2-ethylhexanoate or zinc naphthenate.

Examples of particularly suitable lead complexes are lead octoate, lead neodecanoate or lead 2-ethylhexanoate.

Examples of particularly suitable iron(III) complexes are iron(III) octoate, iron(III) neodecanoate or iron(III) acetylacetonate.

zinc and lead and iron(III) complexes of this kind are available commercially, for example, from ABCR GmbH & Co (Deutschland), Alfa Aersar GmbH & Co (Deutschland), Shepherd Chemical Company (USA) or Gelest Inc. (USA).

It may well be of advantage to use lead and/or zinc and/or iron(III) complexes in a mixture with one another. Furthermore, under certain circumstances, it may also be advantageous to use lead and/or zinc and/or iron(III) complexes in mixtures with amine complexes.

The accelerator component K2 preferably further comprises a liquid carrier medium, more particularly a plasticizer or solvent. In a further preferred embodiment, the accelerator component K2 further comprises thixotropic agents. A thixotropic agent of this kind may be inorganic in nature, such as fumed silica, available commercially for example as Aerosil® from Degussa AG (Deutschland), or organic in nature, such as urea-based thixotropic agents, for example. One preferred organic thixotropic agent is a urea-based thixotropic agent in a carrier medium. Suitable urea derivatives in a carrier medium are, more particularly, reaction products of an aromatic monomeric diisocyanate with an aliphatic amine compound. It is also entirely possible for two or more different monomeric diisocyanates to be reacted with one or more aliphatic amine compounds, or for one monomeric diisocyanate to be reacted with two or more aliphatic amine compounds. The reaction product of 4,4′-diphenylmethylene diisocyanate (MDI) with butylamine has proven to be particularly advantageous.

The urea derivative is present in a carrier material. The carrier material may be a plasticizer, more particularly a phthalate or an adipate, preferably a diisodecyl phthalate (DIDP) or dioctyl adipate (DOA). The carrier medium may also be a blocked polyurethane prepolymer. The preparation of such preferred urea derivatives and carrier materials are described in detail in patent application EP 1 152 019 A1. The carrier material is advantageously a blocked polyurethane prepolymer, obtained in particular by reaction of a trifunctional polyether polyol with IPDI and subsequent blocking of the terminal isocyanate groups with caprolactam.

The use of plasticizer and/or thixotropic agent in the accelerator component K2 is particularly advantageous if the component K1 is pasty, since in that case the metering and/or incorporation by mixing can take place more easily.

Components K1 and K2 may, furthermore, comprise further constituents. In order to ensure that the two components are stable on storage prior to their mixing, however, it is important that, in the absence of moisture, additional constituents of this kind in the components do not react with other constituents of the same component. Consequently the additional constituents of component K1 must not react with the prepolymer P containing isocyanate groups, while the additional constituents of the accelerator component K2 must not react with the catalyst C.

Examples of possible such additional constituents of components K1 and K2 are
plasticizers, examples being esters of organic carboxylic acids or their anhydrides, such as phthalates, examples being dioctyl phthalate, diisononyl phthalate or diisodecyl phthalate, adipates, dioctyl adipate for example, azelates and sebacates, polyols, examples being polyoxyalkylene polyols or polyester polyols, organic phosphoric and sulfonic esters or polybutenes;
solvents;
inorganic and organic fillers, examples being ground or precipitated calcium carbonates, optionally coated with stearates, more particularly finely divided coated calcium carbonate, carbon blacks, especially industrially manufactured carbon blacks (identified below as “carbon black”), kaolins, aluminum oxides, silicas, more particularly highly disperse silicas from pyrolysis operations, PVC powders or hollow beads.
Preferred fillers are carbon black, calcium carbonates, more particularly finely divided coated calcium carbonates, highly disperse silicas from pyrolysis operations, and also combinations of these fillers.
Fibers, of polyethylene for example;
pigments, titanium dioxide for example;
polyaldimines, more particularly as described in WO 2004/013088;
catalysts, examples being metal catalysts in the form of organotin compounds such as dibutyltin dilaurate and dibutyltin diacetylacetonate, organobismuth compounds or bismuth complexes;
amino-containing compounds, examples being 1,4-diazabicyclo[2.2.2]octane and 2,2′-dimorpholino-diethyl ether;
rheology modifiers, such as, for example, thickeners, for example urea compounds, polyamide waxes, bentonites or fumed silicas;
adhesion promoters, examples being epoxysilanes, (meth)acrylosilanes, anhydridosilanes or adducts of the aforementioned silanes with primary aminosilanes, and also urea silanes;
dryers, such as vinyltrimethoxysilane, α-functional silanes such as N-(silylmethyl)-O-methyl-carbamates, more particularly N-(methyldi-methoxysilylmethyl)-O-methyl-carbamate, (methacryloyloxymethyl)silanes, methoxymethyl-silanes, N-phenyl-, N-cyclohexyl-, and N-alkyl-silanes, orthoformic esters, calcium oxide or molecular sieves;
stabilizers against heat, light radiation, and UV radiation;
flame retardants;
surface-active substances, such as wetting agents, flow control agents, deaerating agents or defoamers, for example;
biocides, such as, for example, algaecides, fungicides or fungal growth inhibitor substances;
   and also other substances used typically in moisture-curing compositions.

More particularly these additional constituents ought preferably not to contain any water, or to contain, at most, traces of water. It may therefore be sensible to subject certain constituents to chemical or physical drying before they are mixed into the components.

It has been found particularly favorable for component K1 and, where appropriate, component K2 to comprise filler, more particularly carbon black. Components K1 which have proven particularly advantageous are those which have a filler content, preferably carbon black content, of 5% to 35% by weight, more particularly of 10% to 20% by weight.

The metering of the catalyst C in the accelerator component K2 is preferably such that the catalyst C is present in an amount of 0.01%-0.3% by weight, more particularly 0.04%-0.1% by weight, of metal, i.e., of lead, zinc or iron(III), based on the weight of the adhesive or sealant composition.

Component K1 is preferably pasty and firm. The accelerator component K1 is likewise preferably pasty.

Separate from one another, both components, K1 and K2, are storage-stable; that is, in particular in the absence of moisture, they can be kept in a suitable pack or facility, such as a drum, a pouch or a cartridge, for example, for a period of several months up to one year or more, without suffering any service-relevant change in their application properties or in their properties after curing. Typically the storage stability is determined via the measurement of the viscosity, the extrusion quantity or the extrusion force.

In the two-component composition components K1 and K2 are preferably formulated such that the volume ratio of the first component K1 to the accelerator component K2 has a value of 100:1 to 1:1, more particularly 100:1 to 10:1, preferably 100:1 to 20:1.

By varying the amount of the catalyst C which is admixed to an existing first component K1, which, for example, is a moisture-curing one-component polyurethane adhesive of the kind marketed commercially by Sika Schweiz AG under the product range name Sikaflex®, it is possible in an elegant way to obtain adhesives and sealants which can be adjusted optimally to the prevailing ambient climatic conditions, more particularly to the temperature and the relative humidity, in order to ensure that the cure rate and adhesion meet the requirements.

Thus it is possible on the one hand, for example, to form different accelerator components K2, such as a summer and a winter accelerator component K2, for example, which differ from one another in the concentration of the catalyst C, and to admix them to an existing component K1 in a fixed mixing ratio K1/K2.

Alternatively, on the other hand, it is possible to admix different amounts of an accelerator component K2 with a given concentration of catalyst C to an existing component K1, i.e., with variation of the mixing ratio K1/K2.

In both cases, for the same component K1, both in the winter and in the summer, an adhesion and cure rate that meet the requirements are the result. This aspect of the invention makes it possible to avoid having to produce a winter version and a summer version of adhesives. This means that relatively large amounts of a single adhesive can be produced, and all that it is necessary to do is to produce accelerator components, separately, which can of course be put to optimum use for different adhesives. The use of this modular adhesive/accelerator concept is therefore of great financial advantage and is possible only by virtue of the fact that this system is very tolerant to errors in metering and mixing quality.

For the application of the adhesive or sealant composition a method is used which comprises the following steps:
(i) mixing the two components K1 and K2 of an adhesive or sealant composition as described above;
(ii) applying the components mixed according to step (i) to an adherend surface S1;
(iii) contacting the components mixed according to step (i) with a second adherend surface S2;
(iv) curing the mixed components under the influence of water, more particularly in the form of atmospheric moisture.

The mixing of the two components takes place preferably by a method for mixing a two-component adhesive or sealant composition as described above, in which the accelerator component K2 is admixed to the component K1 immediately prior to the application or during the application. Admixing takes place more particularly by the accelerator component K2 being admixed to component K1 prior to the entry of component K1 into a static mixer. In certain cases it may also be of advantage for the mixing of component K1 with accelerator component K2 to take place in a dynamic mixer.

In both cases preference is given for components K1 and K2 to be mixed virtually homogeneously after mixing—in other words, apart from small domains, their mixing is completely homogeneous. Mixing of this kind is identified more particularly as being virtually homogeneous when, in the case that the two components are colored differently for example, black and white, or red and white, the mixed color after mixing is homogeneous, without streaks or stripes.

The great advantage of the present two-component adhesive or sealant composition, however, is above all the fact that, owing to the fact that primarily a catalyst C and not an isocyanate-reactive component is admixed to an isocyanate component, there is no need for complete mixing. The reason for this is that, on the one hand, the catalyst C is a small molecule, which is able to diffuse easily into the isocyanate component K1, and, on the other hand, the catalyst C accelerates only the reaction of the isocyanate groups, but is otherwise not involved in the crosslinking reaction. Where the two components are mixed at least to a certain extent, the constituents of the accelerator component K2 that have not been fully mixed in do not result in any reduction, or result only in a slight reduction, in the mechanical properties of the cured composition. The smallest quantities of isocyanate-reactive constituents, which may possibly be present in the accelerator component at less than 1% by weight, and which can therefore be considered merely traces, do not alter this advantage. In the case of a relatively large amount of such isocyanate-reactive constituents, however, the weaknesses in mechanical properties that are known for conventional two-component polyurethane systems may occur to an increasing extent. In the case of the conventional two-component polyurethane compositions, in which the second component is composed essentially of an isocyanate-reactive constituent, more particularly a polyol and/or a polyamine, indeed, the NCO-reactive components must react with the polyisocyanate of the isocyanate component via an addition reaction, whereas, in the case of the present composition, the curing after the composition has been applied takes place via the moisture in the air, and the composition of the invention is therefore “moisture-curing”.

Accordingly, when mixing the composition of the invention, the demands made on metering accuracy and mixing quality are less exacting than in the case of conventional two-component polyurethanes.

When the two components K1 and K2 are mixed in the presence of moisture, more particularly of atmospheric moisture, component K1 undergoes curing. In comparison to the curing of component K1 with moisture alone, i.e., without the presence of the accelerator component K2, however, the curing is more rapid. The rate of curing is dependent on factors including the amount of admixed catalyst C, the temperature of the adhesive, the substrate and/or the environment, and also the amount of water needed for the reaction, i.e., more particularly, the relative atmospheric humidity. Consequently it is possible, by varying the amount of catalyst, in a simple way to obtain adhesive and sealant compositions which are optimally adjusted for the different climatic conditions that prevail, for example, in summer and in winter, in respect of adhesion and cure rate.

Curing by means of atmospheric moisture is accompanied first by the formation of a skin on the surface of the composition. The so-called skinning time, accordingly, represents a measure of the cure rate. Typically the skinning time of this kind worth aiming for is up to 4 hours, preferably up to 2 hours, at 23° C. and 50% relative humidity. In the cured state, the composition combines high mechanical strength with high extensibility, and also good adhesion properties. As a result it is suitable for a multiplicity of applications, more particularly as an elastic adhesive, an elastic sealant or an elastic coating. It is suitable more particularly for applications which require rapid curing and impose high requirements on extensibility, in conjunction with high requirements on the adhesion properties and the strengths.

Suitable applications are, for example, the adhesive bonding of components in construction or civil engineering and in the manufacture or repair of industrial products or consumer goods, more particularly of windows, household appliances or means of transport, such as water or land vehicles, preferably automobiles, buses, trucks, trains or boats; the sealing of joints, seams or cavities in industrial manufacture or repair, or in construction or civil engineering.

Elastic adhesive bonds in vehicle construction are, for example, the adhesive attachment of parts, such as plastic covers, trim strips, flanges, bumpers, driver's cabs or other components for installation, to the painted bodywork of a means of transport, or the adhesive installation of windows into the bodywork. Examples of vehicles to be mentioned include automobiles, trucks, buses, rail vehicles and boats.

In one preferred embodiment the composition described is used as an elastic adhesive or sealant.

As an elastic adhesive the composition typically has a breaking extension of at least 200%, and as an elastic sealant it has one of at least 500% at room temperature.

In the context of the method of application, after the two components K1 and K2 have been mixed, the mixed components are applied to an adherend surface S1. Application takes place typically by means of a nozzle, in the form of a triangular or circular bead. Application takes place preferably by means of a suitable apparatus to the substrate. Suitable application methods are, for example, application from commercially customary cartridges, which are operated manually or by means of compressed air, or from a drum or hobbock by means of a conveying pump or an extruder, where appropriate by means of an application robot. An adhesive or sealant having good application properties features high firmness of consistency and short stringing. That is, it remains in the applied form following application, in other words does not run apart, and, after the application device has been set down, it forms only a very short string, if any at all, so that the substrate is not fouled.

Following the application of the mixed components to the adherend surface S1, in a further step, the mixed components thus mixed and applied are contacted with a second adherend surface S2 and cured under the influence of water, more particularly in the form of atmospheric moisture.

In the case of sealing, the sealant composition is typically injected into a gap, and so in this case the application of the mixed composition to the adherend surface S1 and the contacting with the second adherend surface S2 may take place simultaneously. It is therefore clear that, in the adhesive or sealant application method described, steps (ii) and (iii) may take place in succession or simultaneously.

The adherend surfaces S1 and S2 may be different. They may be alike or different from one another in shape and/or material.

Suitable adherend surfaces S1 or S2 are, for example, surfaces of inorganic substrates, such as glass, glass ceramic, concrete, mortar, brick, tile, plaster, and natural stones, such as granite or marble; metals or alloys, such as aluminum, steel, nonferrous metals, galvanized metals; organic substrates, such as wood, plastics such as PVC, polycarbonates, PMMA, polyesters, epoxy resins; coated substrates, such as powder-coated metals or alloys; and also paints and finishes, more particularly automobile topcoats.

If necessary the substrates can be pretreated before the adhesive or sealant is applied. Pretreatments of this kind include, more particularly, physical and/or chemical cleaning techniques, examples being abrading, sandblasting, brushing or the like, or treatment with cleaners or solvents, or the application of an adhesion promoter, adhesion promoter solution or primer.

Surprisingly it has emerged that, in spite of the accelerated cure of the composition, the adhesion is not adversely affected. It has emerged more particularly that rapid curing and good adhesion to painted substrates are present simultaneously. Particularly surprising is the high level of adhesion of the cured composition of the invention to paints, more particularly to painted metals and alloys, preferably to automobile topcoats. Indeed, a large number of such automobile topcoats are known to exhibit weaknesses in adhesion with existing two-component polyurethane adhesives.

Consequently the composition of the invention is suitable more particularly for the sealing and/or adhesive bonding of automobile topcoat substrates.

It is clear to the person skilled in the art that the contacting with the second adherend surface must take place within the time known as the open time, so that an adhesive bond with good adhesion can form.

An adhesively bonded or sealed article is obtained by way of an adhesive or sealant application method as described above. An article of this kind may be a built structure, more particularly a built structure in construction or civil engineering, or may be a means of transport, such as a water or land vehicle, for example, more particularly an automobile, a bus, a truck, a train or a boat, or a component for installation therein or thereon.

With particular preference the adhesively bonded article on the one hand is a window of a means of transport, on the other hand a means of transport or a component for installation on or in a means of transport. The means of transport is preferably a road vehicle or a rail vehicle, more particularly an automobile or a bus or truck.

The window is with preference, more particularly, a glass window printed with glass ceramic, of the kind employed, for example, as a front, side or rear windshield in automobiles. In vehicle glazing, not only in OEM glazing, i.e., during vehicle manufacture, but also in repair glazing, i.e., for example, the replacement of windows damaged due to stonechipping, a high cure rate and effective adhesion are a substantial advantage.

### EXAMPLES

### Preparation of Adhesive Base Formulation

A first prepolymer P (P1) was prepared as follows:

590 g of Acclaim® 4200 N polyol (Bayer), 1180 g of Caradol® MD34-02 polyol (Shell), and 230 g of isophorone diisocyanate (IPDI; Vestanat® IPDI, Degussa) were reacted by a known method at 80° C. to give an NCO-terminated prepolymer. The reaction product had a free isocyanate group content, as determined by titrimetry, of 2.12% by weight.

A second prepolymer P (P2) was prepared as follows:

1300 g of polyoxypropylene diol (Acclaim® 4200 N, Bayer; OH number 28.5 mg KOH/g), 2600 g of polyoxypropylene-polyoxyethylene triol (Caradol® MD34-02, Shell; OH number 35.0 mg KOH/g), 605 g of 4,4′-methylenediphenyl diisocyanate (MDI; Desmodur® 44 MC L, Bayer) and 500 g of diisodecyl phthalate (DIDP; Palatinol® Z, BASF) were reacted at 80° C. to give an NCO-terminated polyurethane polymer having a free isocyanate group content of 2.07% by weight and a viscosity at 20° C. of 48 Pa·s.

The following adhesive base was prepared as an example of a component K1, as follows, in a way which is known to the person skilled in the art:

28.4 g of prepolymer P1 and 139.5 g of prepolymer P2 were processed with 73.0 g of diisodecyl phthalate (DIDP; Palatinol® Z, BASF) and 47.0 g of carbon black and also 71.3 g of calcium carbonate in a vacuum mixer in the absence of moisture to give a lump-free, homogeneous paste.

The component K1 thus prepared was immediately dispensed into moisture tight aluminum cartridges.

As component K2, the catalyst specified in table 1 was mixed, in the amount indicated therein, with the indicated solvent.

Components K1 and K2 were mixed in each case in a ratio of 360 g of K1 to 6 g of K2 (60:1).

TABLE 1
Compositions

| | Ref. 1 | Ref. 2 | Ref. 3 | Ref. 4 | Ref. 5 | Ref. 6 | 1 | 2 | 3 |
|---|---|---|---|---|---|---|---|---|---|
| K1 [g] | 360 | 360 | 360 | 360 | 360 | 360 | 360 | 360 | 360 |
| K2 [g] | | | | | | | | | |
| Diisodecyl phthalate (DIDP [g] | 4.20 | 4.20 | 4.20 | 5.36 | 4.80 | 5.54 | | 5.41 | 3.77 |
| Methyl ethyl ketone [g] | | | | | | | 4.86 | | 1.80 |
| Dimorpholinodiethyl ether (DMDEE) [g] | 1.80 | | | | | | | | |
| N-methyldicyclohexylamine [g] | | 1.80 | | | | | | | |
| Dibutyltin dilaurate (DBTL) [g] | | | 0.97 | | | | | | |
| Bismuth octoate [g] | | | | 0.64 | | | | | |
| Molybdenum 2-ethylhexanoate [g] | | | | | 1.20 | | | | |
| Bis(tri-n-butyltin) oxide [g] | | | | | | 0.46 | | | |
| Iron(III) acetylacetonate [g] | | | | | | | 1.14 | | |
| Zinc neodecanoate [g] | | | | | | | | 0.95 | |
| Lead 2-ethylhexanoate [g] | | | | | | | | | 0.43 |
| Total [g] | 6.00 | 6.00 | 6.00 | 6.00 | 6.00 | 6.00 | 6.00 | 6.00 | 6.00 |
| Concentration of metal or amine in | 500 | 500 | 500 | 500 | 500 | 500 | 500 | 500 | 500 |
| composition [ppm] | | | | | | | | | |

| | Ref. 7 | Ref. 8 | 4 | 5 | 6 | 7 | 8 |
|---|---|---|---|---|---|---|---|
| K1 [g] | 360 | 360 | 360 | 360 | 360 | 360 | 360 |
| K2 [g] | | | | | | | |
| Diisodecyl phthalate (DIDP) [g] | 5.11 | | | 4.10 | 3.71 | 2.73 | 2.37 |
| Methyl ethyl ketone [g] | | | 4.70 | | | 1.36 | 1.18 |
| Dibutyltin dilaurate (DBTL) [g] | 0.89 | | | | | | |
| Iron(III) acetylacetonate [g] | | | 1.30 | | | | |
| Zinc neodecanoate [g] | | | | 1.90 | 2.29 | | |
| Lead 2-ethylhexanoate [g] | | | | | | 1.91 | 2.45 |
| Total [g] | 6.00 | | 6.00 | 6.00 | 6.00 | 6.00 | 6.00 |
| Concentration of metal or amine in | 460 | 0 | 568 | 1000 | 1207 | 2221 | 2846 |
| composition [ppm] | | | | | | | |

### Results

The compositions were applied in the form of a circular bead, immediately after mixing, to float glass (Rocholl, Schönbrunn, Germany) (“glass”) and also to the following paint panels:
“RK8046”: Clear Coat DuPont RK8046, color silver, (ACT Laboratories)
“RK8046”: Clear Coat DuPont RK8013, color silver (ACT Laboratories)
“FF98-0001” Topcoat BASF FF98-0001 (BASF Coatings AG)

Prior to the application of the mixed adhesive, the glass was pretreated with isopropanol or with Sika® Aktivator, available commercially from Sika Schweiz AG, and left to dry in air for 10 minutes.

The paint panels were unpretreated or pretreated by wiping with heptane, and left to dry in air for 10 minutes.

Following the application of the mixed adhesive, the adhesion was tested as follows following storage at 23° C./50% relative humidity for 7 days.

To test the adhesion, an incision was made into one end of the cured bead just above the surface of the plaque (bond face). The incised end of the bead was held by hand and then pulled carefully and slowly from the plaque surface with a peeling action in the direction of the other end of the bead. If, in the course of this removal, the adhesion was so strong that the end of the bead threatened to tear off when being pulled, a cutter was used to apply a cut perpendicular to the bead-pulling direction down to the bare surface of the plaque, and in this way a section of bead was detached. Cuts of this kind were repeated, if necessary, in the course of continued pulling, at intervals of 2 to 3 mm. In this way the entire bead was pulled and/or cut from the plaque. The adhesion properties were evaluated on the basis of the cured sealant or adhesive which remained on the substrate surface after the bead had been removed (cohesive fracture), this being accomplished by estimation of the cohesive fraction of the adhesion area, in accordance with the following scale:

1=more than 95% cohesive fracture
2=75%-95% cohesive fracture
3=25%-75% cohesive fracture
4=less than 25% cohesive fracture
5=0% cohesive fraction (purely adhesive fracture)

Test results with cohesive fracture values of less than 75%, i.e., scores of 3 and 4 and 5, are considered inadequate.

TABLE 2
Adhesion of the compositions to different surfaces S1.

| | Ref. 1 | Ref. 2 | Ref. 3 | Ref. 4 | Ref. 5 | Ref. 6 | 1 | 2 | 3 |
|---|---|---|---|---|---|---|---|---|---|
| Glass | | | | | | | | | |
| PT*: Sika ® Aktivator | 1 | 1 | 1 | 1 | 1 | 1 | 1 | 1 | 1 |
| PT*: Isopropanol | 5 | 5 | 5 | 5 | 5 | 5 | 5 | 5 | 5 |
| RK8046 | | | | | | | | | |
| PT*: Heptane | 5 | 5 | 2 | 3 | 3 | 5 | 1 | 1 | 1 |
| PT*: None | 5 | 5 | 2 | 5 | 3 | 5 | 1 | 4 | 1 |
| RK8013 | | | | | | | | | |
| PT*: Heptane | 5 | 3 | 2 | 4 | 5 | 5 | 1 | 2 | 1 |
| PT*: None | 5 | 5 | 3 | 5 | 5 | 5 | 2 | 5 | 2 |
| FF98-0001 | | | | | | | | | |
| PT*: Heptane | 5 | 5 | 4 | 2 | 3 | 4 | 1 | 2 | 1 |
| PT*: None | 5 | 5 | 4 | 3 | 3 | 4 | 1 | 4 | 2 |

*PT = pretreatment

### Skinning Times

As a measure of the cure rate, the skinning time was ascertained.

For this purpose a thin layer (2 mm) of the composition, immediately after the mixing of components K1 and K2, was applied to cardboard and stored at 23° C./50% relative humidity. The nature of the sample's surface was investigated by contacting the sample with the hind part of a disposable polyethylene pipette. The skinning time (t_{SO}) is the time from the point of mixing to the moment at which contact with the pipette no longer pulls a string from the composition.

TABLE 3
Skinning time tₛₒ of the compositions.

| | Ref. 3 | Ref. 7 | Ref. 8 | 1 | 2 | 3 | 4 | 5 | 6 | 7 | 8 |
|---|---|---|---|---|---|---|---|---|---|---|---|
| tₛₒ | 20 | 35 | >>240 | 45 | 224 | 223 | 75 | 120 | 190 | 89 | 90 |
| [min] | | | | | | | | | | | |
| Metal | Sn | Sn | — | Fe | Zn | Pb | Fe | Zn | Zn | Pb | Pb |
| Conc. | 500 | 460 | — | 500 | 500 | 500 | 568 | 1000 | 1207 | 2221 | 2846 |
| [ppm] | | | | | | | | | | | |

From the results of table 3 it is apparent that the compositions 1 to 8 exhibit accelerated curing. It is also evident, however, that the catalysts C have a less strongly accelerating action in comparison to dibutyltin dilaurate.

### Storage Tests on One-Component Compositions

Component K1 used in the preceding examples was modified in that, during its preparation, at the end, the amount of catalyst indicated in table 3 was mixed in additionally and the mixture was stored in sealed aluminum cartridges in the absence of moisture. Following storage of these sealed cartridges, after 2 days at room temperature (“EF1”), or 7 days at 60° C. (“EF2”), or 2 days at 70° C. (“EF3”), the extrusion force (EF) was determined as follows:

For the determination of the extrusion force, a cartridge filled with adhesive was conditioned at 23° C. for 12 hours and then opened, and a 5 mm nozzle was screwed on. Using a Zwick 1120 extrusion device, a determination was made of the force required to extrude the adhesive at an extrusion rate of 60 mm/min. The value reported is an average value after extrusion of 140 ml.

TABLE 4
Storage stability of one-component
compositions comprising catalyst.

| | | | Extrusion | | | | |
|---|---|---|---|---|---|---|---|
| | | | force | | | | |
| | | | EF1 | | | | |
| | | | 2 d/ | EF2 | | EF3 | |
| | | | 23° C. | 7 d/60° C. | | 2 d/70° C. | |
| | | Amount | EF1 | EF2 | EF2 | EF3 | EF3 |
| | Catalyst | [ppm] | [N] | [N] | EF1 | [N] | EF1 |
| Ref. 9 | Dibutyltin | 460 | 490 | 690 | +41% | 733 | +50% |
| | dilaurate | | | | | | |
| | (DBTL) | | | | | | |
| Ref. 10 | Iron(III) | 568 | 360 | 532 | +48% | 587 | +63% |
| | acetyl- | | | | | | |
| | acetonate | | | | | | |

| | | | | | |
|---|---|---|---|---|---|
| Ref. 11 | Zinc | 1207 | 535 | un- | un- |
| | neodecanoate | | | measurable | measurable |
| Ref. 12 | Lead 2- | 2846 | 572 | un- | un- |
| | ethyl- | | | measurable | measurable |
| | hexanoate | | | | |

The results from table 4 show that the catalysts C in a one-component composition lead to the compositions not being stable on storage, in comparison to the standard catalysts (Ref. 9).

### Production of Adhesive Bonds

The following adhesive bonds were produced by applying the mixed compositions of examples 1, 2 and 3 to the glass region, or to the ceramic-coated edge region (both pretreated with Sika® Aktivator, Sika Schweiz AG) of an automobile's front window (original window of a Ford Fiesta), in the form of a triangular bead, and then pressing (contacting) the painted automobile topcoat panels—panels RK8046, RK8013, and FF98-0001 (cleaned with heptane) onto these beads. After curing for 7 days, the adhesion was rated. All of the samples exhibited excellent adhesion. When the panel was peeled off using round-end tweezers, cohesive fracture within the adhesive was found in all of the samples, in other words both on glass and on glass ceramic.

1. A two-component adhesive or sealant composition composed of
a first component K1
which comprises at least one prepolymer P which contains isocyanate groups and is prepared from at least one polyisocyanate and at least one polyol;
and an accelerator component K2
which contains less than 1% by weight, based on the accelerator component, of compounds containing isocyanate-reactive groups;
and which further comprises at least one catalyst C which catalyzes the reaction of isocyanate groups and which is a lead complex or a zinc complex or an iron(III) complex.

2. The two-component adhesive or sealant composition of claim 1, wherein the first component K1 comprises a filler, based on the weight of the first component K1.

3. The two-component adhesive or sealant composition of claim 1, wherein the accelerator component K2 comprises a urea-based thixotropic agent in a carrier medium.

4. The two-component adhesive or sealant composition of claim 3, wherein the carrier medium is a blocked polyurethane prepolymer.

5. The two-component adhesive or sealant composition of claim 1, wherein the catalyst C is present in an amount of 0.01%-0.3% by weight, of metal, based on the weight of the adhesive or sealant composition.

6. The two-component adhesive or sealant composition of claim 1, wherein the volume ratio of the first component K1 to the accelerator component K2 is a value from 100:1 to 1:1.

7. The two-component adhesive or sealing composition of claim 1, wherein the complex C is a lead complex and the lead complex comprises at least one organic ligand attached to the lead atom via oxygen atoms.

8. The two-component adhesive or sealing composition of claim 1, wherein the complex C is a zinc complex and the zinc complex comprises at least one organic ligand attached to the zinc atom via oxygen atoms.

9. The two-component adhesive or sealing composition of claim 1, wherein the complex C is an iron(III) complex and the iron(III) complex comprises at least one organic ligand attached to the iron(III) atom via oxygen atoms.

10. A method of mixing a two-component adhesive or sealing composition of claim 1, wherein the accelerator component K2 is admixed to component K1 immediately before the application or during the application.

11. The method of claim 10, wherein the admixing of the accelerator components K2 to the component K1 takes place before component K1 enters a static mixer.

12. The method of claim 10, wherein the mixing of component K1 with accelerator component K2 takes place in a dynamic mixer.

13. An adhesive or sealant application method, wherein it comprises the following steps:
(i) mixing the two components K1 and K2 of an adhesive or sealant composition of any one of claims 1 to 9;
(ii) applying the components mixed according to step (i) to an adherend surface S1;
(iii) contacting the components mixed according to step (i) with a second adherend surface S2; and
(iv) curing the mixed components under the influence of water.

14. The adhesive or sealant application method of claim 13, wherein at least one adherend surface S1 or S2 is a coating-material surface.

15. An adhesively bonded article bonded according to an adhesive or sealant application method of claim 13.

16. The adhesively bonded article of claim 15, wherein the article is a window sheet of a means of transport.

17. The adhesively bonded article of claim 15, wherein the article is a means of transport or a component for installation on a means of transport.

18. The adhesively bonded article of claim 17, wherein the means of transport is a road vehicle or a rail vehicle.
